(19) United States
(12) Patent Application Publication
(10) Pub. No.: US 2026/0046346 A1
(43) Pub. Date: Feb. 12, 2026

(54) METHOD AND APPARATUS FOR DETERMINING COMPRESSION MODEL USED FOR COMPRESSING CHANNEL STATE INFORMATION, AND STORAGE MEDIUM

(71) Applicant: BEIJING XIAOMI MOBILE SOFTWARE CO., LTD., Beijing (CN)

(72) Inventor: Min LIU, Beijing (CN)

(73) Assignee: BEIJING XIAOMI MOBILE SOFTWARE CO., LTD., Beijing (CN)

(21) Appl. No.: 18/998,272

(22) PCT Filed: Aug. 3, 2022
(86) PCT No.: PCT/CN2022/110091

§ 371 Date: Jan. 24, 2025

(51) Int. Cl. H04L 69/04; H04B 7/06

(52) U.S. Cl. CPC H04L 69/04; H04B 7/0626

(57) ABSTRACT

A method for determining a compression model for compressing channel state information, performed by a terminal, includes: receiving model information sent by a network device, the model information comprising a first model parameter of a decompression model, and the decompression model being used by the network device to decompress the channel stage information sent by the terminal; and determining the compression model used by the terminal to compress the channel state information based on the model information.

### CROSS-REFERENCE TO RELATED APPLICATIONS

The present application is a U.S. National Stage of International Application No. PCT/CN2022/110091, filed on Aug. 3, 2022, the content of which is incorporated herein by reference in its entirety for all purposes.

### FIELD

The present disclosure relates to the technical field of communication technologies, and more particularly to a method and a device for determining a compression model for compressing channel state information and a storage medium.

### BACKGROUND

In the field of wireless communications, channel state information (CSI) is the channel property of the communication link. It describes the attenuation factor of the signal on each transmission path, that is, the value of each element in the channel gain matrix, such as signal scattering, environmental fading (multipath fading or shadowing fading), power decay of distance and other information. CSI may make the communication system adapt to the current channel conditions and provide a guarantee for high-reliability and high-speed communication in a multi-antenna system.

### SUMMARY

According to a first aspect of the present disclosure, a method for determining a compression model for compressing channel state information is provided, the method is performed by a terminal, and includes: receiving model information sent by a network device, in which the model information includes a first model parameter of a decompression model, and the decompression model is used by the network device to decompress the channel state information sent by the terminal; and determining the compression model used by the terminal to compress the channel state information based on the model information.

According to a second aspect of the present disclosure, a method for determining a compression model for compressing channel state information is provided, which is performed by a network device, and includes: sending model information, in which the model information includes a first model parameter of a decompression model, the decompression model is used by the network device to decompress the channel state information sent by a terminal, and the model information is used by the terminal to determine the compression model for compressing the channel state information.

According to a third aspect of the present disclosure, a device for determining a compression model for compressing channel state information is provided, and the device includes: a processor; a memory for storing instructions executable by the processor; in which the processor is configured to: receive model information sent by a network device, in which the model information includes a first model parameter of a decompression model, the decompression model is used by the network device to decompress the channel state information sent by the terminal; and determine the compression model used by the terminal to compress the channel state information based on the model information.

According to a fourth aspect of the present disclosure, a device for determining a compression model for compressing channel state information is provided, and the device includes: a processor; a memory for storing instructions executable by the processor; in which the processor is configured to perform the method according to the second aspect.

### BRIEF DESCRIPTION OF THE DRAWINGS

The aspects and advantages of the present disclosure will become apparent and easily understood from the following description of the embodiments in conjunction with the accompanying drawings.

FIG. 1A is a schematic diagram of a network system architecture in the related art.

FIG. 1B is another schematic diagram of a network system architecture in the related art.

FIG. 2 is a flow chart showing a method for determining a compression model for compressing channel state information according to an illustrative embodiment.

FIG. 3 is a flow chart showing a method for determining a compression model for compressing channel state information according to an illustrative embodiment.

FIG. 4 is a flow chart showing a method for determining a compression model for compressing channel state information according to an illustrative embodiment.

FIG. 5 is a flow chart showing a method for determining a compression model for compressing channel state information according to an illustrative embodiment.

FIG. 6 is a flow chart showing a method for determining a compression model for compressing channel state information according to an illustrative embodiment.

FIG. 7 is a flow chart showing a method for determining a compression model for compressing channel state information according to an illustrative embodiment.

FIG. 8 is a flow chart showing a method for determining a compression model for compressing channel state information according to an illustrative embodiment.

FIG. 9 is a flow chart showing a method for determining a compression model for compressing channel state information according to an illustrative embodiment.

FIG. 10 is a flow chart showing a method for determining a compression model for compressing channel state information according to an illustrative embodiment.

FIG. 11 is a flow chart showing a method for determining a compression model for compressing channel state information according to an illustrative embodiment.

FIG. 12 is a flow chart showing a method for determining a compression model for compressing channel state information according to an illustrative embodiment.

FIG. 13 is a flow chart showing a method for determining a compression model for compressing channel state information according to an illustrative embodiment.

FIG. 14 is a flow chart showing a method for determining a compression model for compressing channel state information according to an illustrative embodiment.

FIG. 15 is a flow chart showing a method for determining a compression model for compressing channel state information according to an illustrative embodiment.

FIG. 16 is a flow chart showing a method for determining a compression model for compressing channel state information according to an illustrative embodiment.

FIG. 17 is a flow chart showing a method for determining a compression model for compressing channel state information according to an illustrative embodiment.

FIG. 18 is a flow chart showing a method for determining a compression model for compressing channel state information according to an illustrative embodiment.

FIG. 19 is a flow chart showing a method for determining a compression model for compressing channel state information according to an illustrative embodiment.

FIG. 20 is a flow chart showing a method for determining a compression model for compressing channel state information according to an illustrative embodiment.

FIG. 21 is an interaction diagram showing a method for determining a compression model for compressing channel state information according to an illustrative embodiment.

FIG. 22 is a block diagram showing a device for determining a compression model for compressing channel state information according to an illustrative embodiment.

FIG. 23 is a block diagram showing a device for determining a compression model for compressing channel state information according to an illustrative embodiment.

FIG. 24 is a block diagram of a terminal according to an illustrative embodiment.

FIG. 25 is a block diagram of a network device according to an illustrative embodiment.

### DETAILED DESCRIPTION

Embodiments of the present disclosure are described in detail below, examples of which are shown in the accompanying drawings, the same or similar reference numerals represent the same or similar elements or elements having the same or similar functions. The embodiments described below with reference to the accompanying drawings are illustrative and are intended to be used to explain the present disclosure, and should not be construed as limiting the present disclosure.

In the wireless communication field, channel state information (CSI) is the channel property of the communication link. It describes the attenuation factor of the signal on each transmission path, that is, the value of each element in the channel gain matrix, such as signal scattering, environmental fading (multipath fading or shadowing fading), power decay of distance and other information. CSI may make the communication system adapt to the current channel conditions and provide a guarantee for high-reliability and high-speed communication in a multi-antenna system.

In related technologies, CSI enhancement based on Artificial Intelligence (AI) models has become an industry trend. However, the deployment and transmission methods of AI models used for CSI enhancement in related technologies cannot meet the needs of different manufacturers for the privatization of model parameters and model data.

In order to solve the above problems, the embodiments of the present disclosure provide a method and a device for determining a compression model for compressing channel state information, and a storage medium.

The following first introduces the implementation environment of an embodiment of the present disclosure.

Embodiments of the present disclosure may be applicable to fourth generation mobile communication system (4G) evolution systems, such as long term evolution (LTE) systems, or may also be fifth generation mobile communication (5G) systems, such as access networks using new radio access technology (New RAT); cloud radio access network (CRAN) and other communication systems.

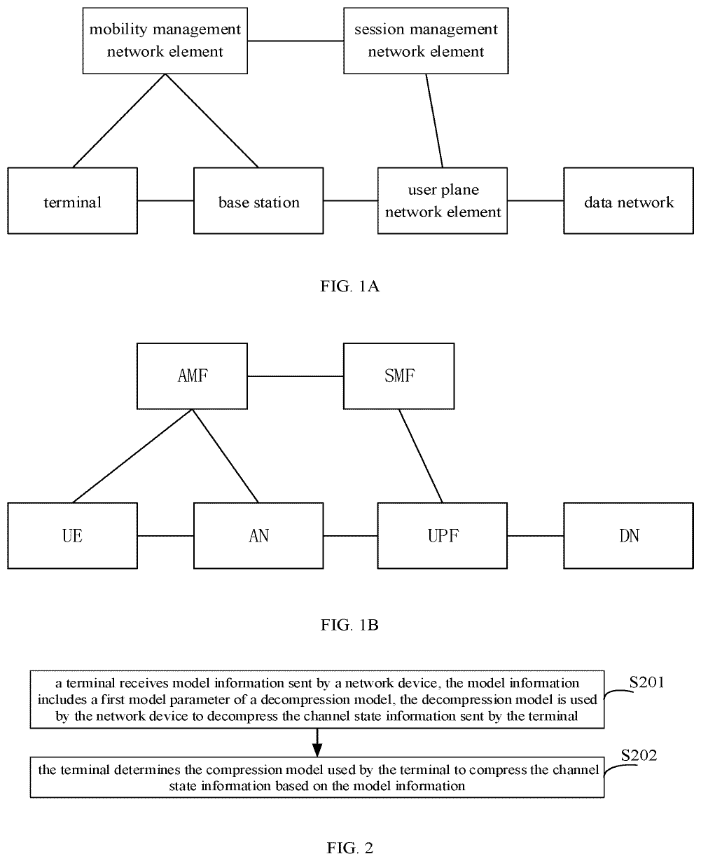

FIG. 1A shows a schematic diagram of a system architecture according to an embodiment of the present disclosure. It should be understood that an embodiment of the present disclosure is not limited to the system shown in FIG. 1A. In addition, the device in FIG. 1A may be hardware, or software divided in terms of function, or a structure that is a combination thereof. As shown in FIG. 1A, the system architecture provided by an embodiment of the present disclosure includes a terminal, a base station, a mobility management network element, a session management network element, a user plane network element, and a data network (DN). The terminal communicates with the DN via the base station and the user plane network element.

The network element shown in FIG. 1A may be a network element in a 4G architecture or a network element in a 5G architecture.

Data network (DN) provides data transmission services for users and may be a protocol data unit (PDN) network, such as the Internet, IP Multimedia Service (IMS), etc.

FIG. 1B shows the architecture diagram of 5G system. The mobility management network element may include the access and mobility management function (AMF) in 5G. The mobility management network element is responsible for the access and mobility management of terminals in the mobile network. AMF is responsible for terminal access and mobility management, NAS message routing, session management function (SMF) selection, etc. AMF may be used as an intermediate network element to transmit session management messages between the terminal and SMF.

The session management network element is responsible for forwarding path management, such as sending message forwarding policies to user plane network elements, instructing user plane network elements to process and forward messages according to the message forwarding policies. The session management network element may be the SMF in 5G (as shown in FIG. 1B), which is responsible for session management, such as session creation/modification/deletion, user plane network element selection, and allocation and management of user plane tunnel information.

The user plane network element may be a user plane function (UPF) in the 5G architecture, as shown in FIG. 1B. UPF is responsible for message processing and forwarding.

The system architecture provided by an embodiment of the present disclosure may also include a data management network element for processing terminal device identification, access authentication, registration and mobility management, etc. In a 5G communication system, the data management network element may be a unified data management (UDM) network element.

The system architecture provided by an embodiment of the present disclosure may also include a policy control function (PCF) or a policy and charging control function (PCRF), the PCF or PCRF is responsible for policy control decision-making and flow-based charging control.

The system architecture provided by an embodiment of the present disclosure may also include a network storage network element for maintaining real-time information of all network function services in the network. In the 5G communication system, the network storage network element may be a network repository function (NRF) network element. A lot of network element information may be stored in the network repository network element, such as SMF information, UPF information, AMF information, etc. Network elements such as AMF, SMF, and UPF in the network may be connected to NRF. On the one hand, their own network element information may be registered to NRF, and on the other hand, other network elements may obtain information about registered network elements from NRF. Other network elements (such as AMF) may obtain available network elements by requesting NRF based on network element type, data network identifier, unknown area information, etc. If the domain name system (DNS) server is integrated in NRF, then the corresponding selection function network element (such as AMF) may request NRF to obtain other network elements to be selected (such as SMF).

As a specific implementation form of an access network (AN), a base station may also be called an access node. If it is a form of wireless access, it is called a radio access network (RAN), as shown in FIG. 1B, it provides wireless access services for terminals. The access node may be a base station in a global system for mobile communication (GSM) system or a code division multiple access (CDMA) system, or a base station (NodeB) in a wideband code division multiple access (WCDMA) system, or an evolutionary base station (eNB or eNodeB) in an LTE system, or a base station device, a small base station device, a wireless access node (WiFiAP), a worldwide interoperability for microwave access base station (WiMAX BS) in a 5G network, etc., and the present disclosure does not limit this.

Terminals may also be referred to as access terminals, user equipment (UE), user units, user stations, mobile stations, remote stations, remote terminals, mobile devices, user terminals, wireless communication devices, user agents or user devices, etc. FIG. 1B is illustrated by taking UE as an example. The terminal may be a cellular phone, a cordless phone, a session initiation protocol (SIP) phone, a wireless local loop (WLL) station, a personal digital assistant (PDA), a handheld device with wireless communication capabilities, a computing device or other processing device connected to a wireless modem, a vehicle-mounted device, a wearable device, an Internet of Things terminal device, such as a fire detection sensor, a smart water meter/electricity meter, a factory monitoring device, etc.

The above functions may be network elements in hardware devices, software functions running on dedicated hardware, or virtualized functions instantiated on a platform (e.g., a cloud platform).

In an embodiment of the present disclosure, the model deployment is respectively performed on the base station side and the terminal side, the CSI is compressed by the compression model and executed on the terminal side, and the CSI is decompressed by the decompression model and executed on the base station side, and the decompression model and the compression model are used in combination. The model parameters involved in an embodiment of the present disclosure (such as the first model parameter, the second model parameter and the third model parameter) may include configuration variables inside the model and/or configuration variables outside the model (i.e., model hyperparameters). An embodiment of the present disclosure does not limit the types of decompression models and compression models. For example, for a neural network model, the variables configured inside the model may include, for example, a calculation parameter matrix of each neuron node, and the hyperparameter may be, for example, a learning step size for training a neural network, and for a support vector machine, the variables configured inside the model may be, for example, a support vector, and the hyperparameter may be, for example, a sigma parameter of a support vector machine. Taking a neural network as an example, in a possible implementation, the model parameters in an embodiment of the present disclosure may alternatively or additionally include at least one of the following parameters: model type, learning step size, calculation parameter matrix of each neuron node, filling value for filling the calculation parameter matrix, deviation of each neuron node, and activation function of each neuron node.

FIG. 2 is a flow chart showing a method for determining a compression model for compressing channel state information according to an illustrative embodiment, which is applied to a terminal. As shown in FIG. 2, the method includes the following steps.
S201, a terminal receives model information sent by a network device. The model information includes a first model parameter of a decompression model. The decompression model is used by the network device to decompress the channel state information sent by the terminal.
S202, the terminal determines the compression model used by the terminal to compress the channel state information based on the model information.

In a disclosed embodiment, the first model parameter is used to indicate the compression model corresponding to the decompression model of the terminal.

The network device may be an access network device (such as a base station) as shown in FIG. 1A, or it may be other network logic entities in the core network. It should be understood that the communication network includes an access network (such as a base station as shown in FIG. 1A), a bearer network, and a core network (such as a mobility management network element, a session management network element as shown in FIG. 1A, and NRF, AMF as shown in FIG. 1B). The first model parameter of the above-mentioned decompression model may be obtained by the base station through training, and the present disclosure does not specifically limit the training method of the decompression model.

It may be understood that the first model parameter is used to indicate the compression model corresponding to the decompression model of the terminal; the terminal may obtain the compression model for compressing CSI that may be used in conjunction with the decompression model at least based on the first model parameter of the decompression model. For example, the terminal may train and obtain the compression model corresponding to the decompression model based on the first model parameter and the privatized data collected by the terminal.

In an example, the model information may be sent by a base station via an RRC signaling, in which case the network device may be a base station. Alternatively, in another example, the model information may be sent by an AMF in a core network, i.e., an access and mobility management entity, via a non-access stratum (NAS) layer signaling, in which case the network device may be an AMF.

In an example, the model information may be sent when the decompression model deployed in the network device changes, or may be sent in response to a terminal being connected to a base station, or may be sent periodically by the network device at a certain period. When the compression model in the terminal changes, it will not affect the decompression model deployed in the network device, that is, the decompression model of the network device will not be affected by the compression model of the terminal, thereby effectively ensuring that the complexity of the decompression model deployed in the network device will not increase.

In another example, the compression model used by the terminal to compress the channel state information satisfies at least one of the following model performance conditions: a mean square error or a normalized mean square error being less than a first preset threshold in a case that the compression model and the decompression model are used together; a cosine similarity being greater than a second preset threshold in a case that the compression model and the decompression model are used together; a square of the cosine similarity being greater than a third preset threshold in a case that the compression model and the decompression model are used together; or a signal-to-noise ratio being greater than a fourth preset threshold in a case that the compression model and the decompression model are used together.

In some possible implementations, the compression model used by the terminal to compress the channel state information needs to meet the above multiple conditions at the same time. If the compression model cannot meet any of the multiple conditions, the terminal may further adjust the parameters of the compression model, or the network device is asked to resend the model information for the compression model, thereby ensuring that the compression model obtained based on the model information sent by the terminal may reliably compress the channel state information.

In an embodiment, the terminal receives model information sent by the network device and obtains a compression model for compressing the channel state information based on the model information. Since the model information includes the first model parameters of the decompression model of the network device, the terminal may obtain the compression model for use in conjunction with the decompression model of the network device based on the first model parameters and the privatized data of the terminal manufacturer or chip manufacturer. In this process, the network device does not need to know the parameters of the compression model deployed by the terminal, thereby ensuring the privatization of the compression model.

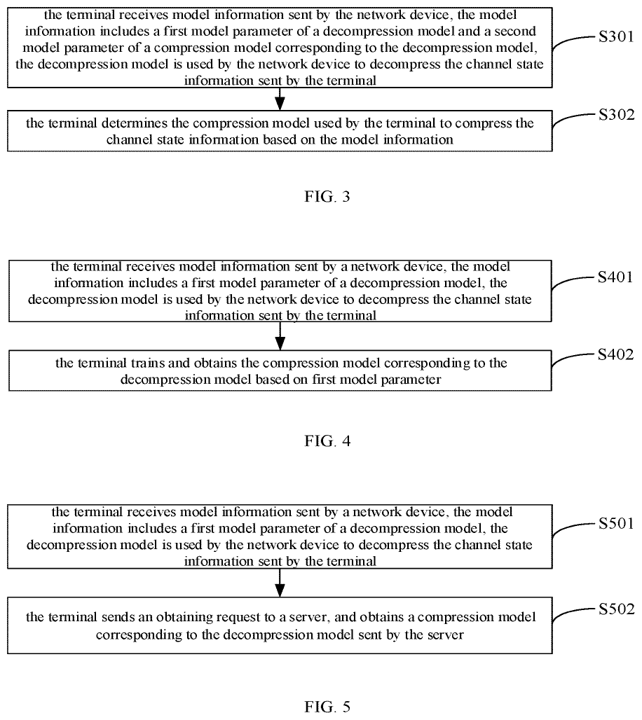

FIG. 3 is a flow chart showing a method for determining a compression model for compressing channel state information according to an illustrative embodiment, which is applied to a terminal. As shown in FIG. 3, the method includes the following steps.
S301, the terminal receives model information sent by the network device. The model information includes a first model parameter of a decompression model and a second model parameter of a compression model corresponding to the decompression model. The decompression model is used by the network device to decompress the channel state information sent by the terminal.
S302, the terminal determines the compression model used by the terminal to compress the channel state information based on the model information.

It is understandable that due to the performance differentiation of different terminal manufacturers or terminal chip manufacturers, there are differences in the capabilities of the terminal (the capabilities of the terminal may include, for example, the hardware capabilities of the terminal, such as its computing power and other information, and the capability information may also include the current state information of the terminal, such as load information, etc.). In step S302, the terminal may determine, based on its own capabilities or other parameters, whether to obtain the compression model based on the first model parameter, or to obtain the compression model based on the second model parameter. In another example, the model information also includes configuration information of a network device (such as a base station), and the terminal may determine, based on the configuration information, whether to use the second model parameter or to obtain the compression model based on the first model parameter. The configuration information may at least be used to indicate whether the terminal directly uses the compression model corresponding to the second model parameter, or whether to adjust the second model parameter.

By adopting this solution, by receiving model information including a first model parameter of a decompression model and a second model parameter of a compression model corresponding to the decompression model, the terminal may obtain the compression model based on the first model parameter, and may also obtain the compression model based on the second model parameter, thereby ensuring that terminals of different terminal manufacturers or terminal chip manufacturers may effectively obtain the compression model.

FIG. 4 is a flow chart showing a method for determining a compression model for compressing channel state information according to an illustrative embodiment, which is applied to a terminal. As shown in FIG. 4, the method includes the following steps.
S401, the terminal receives model information sent by a network device. The model information includes a first model parameter of a decompression model. The decompression model is used by the network device to decompress the channel state information sent by the terminal.
S402, the terminal trains and obtains the compression model corresponding to the decompression model based on first model parameter.

In step S402, the terminal may train and obtain the compression model at least based on the private data of the terminal manufacturer or the chip manufacturer and the first model parameter. The present disclosure does not specifically limit the training method of the compression model.

In an example, the model information also includes a second model parameter of a compression model corresponding to the decompression model. Before step S402 is executed, the terminal may determine whether to execute step S402 according to its capability information, that is, the terminal determines whether the terminal has the ability to train and obtain the compression model corresponding to the decompression model according to the first model parameter. The capability information of the terminal may include the hardware capability of the terminal, such as its computing power, and the capability information may also include the current state information of the terminal, such as load information.

In another example, the terminal may also determine whether to perform step S402 according to the configuration information of the base station, that is, the terminal determines whether the terminal needs to train and obtain the compression model corresponding to the decompression model based on the first model parameter according to the base station configuration information. In a case that the model information also includes the second model parameter of the compression model corresponding to the decompression model, the configuration information may also indicate whether the terminal needs to directly use the second model parameter. In the absence of the base station configuration information, the terminal may decide whether to directly use the second model parameters or obtain the compression model according to the first model parameter based on its own capabilities or other information.

In another example, if the compression model obtained according to step S402 does not meet any one or at least one model performance condition described in the above embodiments, the terminal may retrain and obtain a compression model corresponding to the decompression model based on the first model parameter.

By adopting this solution, the terminal receives the first model parameter in the model information sent by the network device, and trains and obtains the compression model for compressing the channel state information based on the first model parameter. Since the training process of the compression model and/or the compression model parameters are transparent to the network device, the privatization of the compression model is effectively guaranteed.

FIG. 5 is a flow chart showing a method for determining a compression model for compressing the channel state information according to an illustrative embodiment, which is applied to a terminal. As shown in FIG. 5, the method includes the following steps.
S501, the terminal receives model information sent by a network device. The model information includes a first model parameter of a decompression model. The decompression model is used by the network device to decompress the channel state information sent by the terminal.
S502, the terminal sends an obtaining request to a server, and obtains a compression model corresponding to the decompression model sent by the server.

Alternatively or additionally, the training of the model relies on the server corresponding to the terminal side, such as the server of the chip manufacture. After obtaining the first model parameter, the terminals sends the first model parameter to the server corresponding to the terminal side. After completing the training of the compression model, the server sends the compression model to the terminal.

The server may be a third-party server, or a server on the network side, such as a server in the core network, or it may be a server on the terminal side, such as server in a chip manufacturer or a terminal manufacturer. This present disclosure does not limit this.

It may be understood that the obtaining request at least includes the first model parameter of the decompression model, and the obtaining request may also include training data for training the compression model, or the server stores training data for training the compression model.

In an example, the terminal may also train locally to obtain a compression model corresponding to the decompression model. The terminal sends an obtaining request to the server to request the server to train the compression model, or the training locally at the terminal may be determined based on the capability information of the terminal. For example, if the current load of the terminal is greater than a preset threshold, the terminal may send the obtaining request to the server to request the server to train the compression model. If the current load of the terminal is less than the preset threshold, the terminal may train locally.

In another example, the model information also includes a second model parameter of a compression model corresponding to the decompression model. Before step S502 is executed, the terminal may determine whether to execute step S502 according to its capability information, that is, the terminal determines whether the terminal has the ability to train and obtain the compression model corresponding to the decompression model based on the first model parameter according to its capability information. If the terminal does not have the ability to train and obtain the compression model corresponding to the decompression model based on the first model parameter, the compression model may be obtained according to the second model parameter. In addition, whether to execute S502 may also be determined according to the privatization requirements of the terminal. For example, if the terminal has no privatization requirements, step S502 may be omitted, and the compression model may be directly obtained according to the second model parameter.

In another example, the terminal may determine whether to directly use the second model parameters or obtain the compression model based on the first model parameter according to the configuration information of the base station (the model information may include the configuration information). In the absence of the configuration information of the base station, the terminal may decide whether to directly use the second model parameter or obtain the compression model based on the first model parameter according to its own capabilities or other information.

In another example, if the compression model obtained according to step S501 and step S502 does not meet any one or at least one model performance condition described in the above embodiments, the terminal may send an obtaining request to the server again and obtain an updated compression model corresponding to the decompression model.

By adopting the above solution, the terminal sends an obtaining request to the server so that the server trains the compression model, the terminal obtains the compression model for compressing the channel state information. When the terminal cannot train the compression model locally, or the terminal temporarily cannot support the training of the compression model, the compression model may be trained and obtained. While ensuring the privatization of the compression model, it is effectively ensured that terminals of different terminal manufacturers or chip manufacturers may obtain the compression model through training.

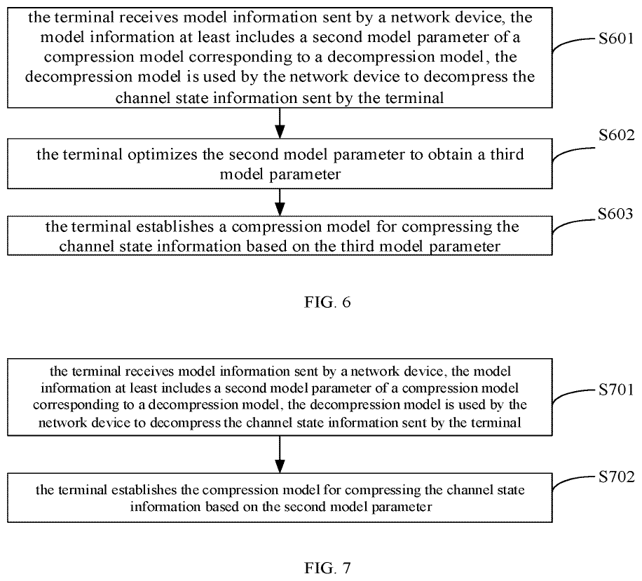

FIG. 6 is a flowchart of a method for determining a compression model for compressing channel state information according to an illustrative embodiment, which is applied to a terminal. As shown in FIG. 6, the method includes the following steps.
S601, the terminal receives model information sent by a network device. The model information at least includes a second model parameter of a compression model corresponding to a decompression model. The decompression model is used by the network device to decompress the channel state information sent by the terminal.
S602, the terminal optimizes the second model parameter to obtain a third model parameter.
S603, the terminal establishes a compression model for compressing the channel state information based on the third model parameter.

In step S602, the second model parameter may be adjusted based on the private data of the terminal manufacturer or chip manufacturer in the terminal, and the adjustment method of the second model parameter is not specifically limited in the present disclosure.

In an example, the terminal determines whether to execute step S602 and step S603 based on its capability information. For example, when it is determined that the capability information of the terminal indicates that the computing power of the terminal does not have the ability to train the compression model but has the ability to adjust the second model parameter, step S602 and step S603 may be executed.

In another example, if the compression model obtained according to step S602 does not meet any one or at least one model performance condition described in the above embodiments, the terminal may further optimize the third model parameter or optimize the second model parameter again to obtain a compression model corresponding to the decompression model.

In an implementation, the model information in step S601 may include the second model parameter of the compression model corresponding to the decompression model. In another implementation, the model information in step S601 may include the first model parameter of the decompression model and the second model parameter of the compression model corresponding to the decompression model.

By adopting the above solution, the terminal receives the second model parameter of the compression model corresponding to the decompression model sent by the network device, and further adjusts the second model parameter to obtain the third model parameter and establishes the compression model according to the third model parameter. In the case of insufficient terminal capacity, the adjusted compression model may be obtained by adjusting the second model parameter sent by the network device, and the parameters of the compression model are transparent to the network device, which may effectively ensure the privatization of the compression model.

FIG. 7 is a flowchart of a method for determining a compression model for compressing channel state information according to an illustrative embodiment, which is applied to a terminal. As shown in FIG. 7, the method includes the following steps.
S701, the terminal receives model information sent by a network device. The model information at least includes a second model parameter of a compression model corresponding to a decompression model. The decompression model is used by the network device to decompress the channel state information sent by the terminal.
S702, the terminal establishes the compression model for compressing the channel state information based on the second model parameter.

In an example, the terminal determines whether to execute step S702 based on its capability information. For example, when it is determined that the capability information of the terminal indicates that the computing power of the terminal does not have the ability to train the compression model or adjust the second model parameters, step S702 may be executed so that the terminal directly applies the model parameters of the compression model sent by the network device.

In another example, if the compression model obtained according to step S702 does not meet any one or at least one model performance condition described in the above embodiments, the terminal may instruct the network device to resend the model information and establish a compression model based on the second model parameter in the model information newly sent by the network device.

In an implementation, the model information in step S701 may include the second model parameter of the compression model corresponding to the decompression model. In another implementation, the model information in step S701 may include the first model parameter of the decompression model and the second model parameter of the compression model corresponding to the decompression model.

By adopting the above solution, the terminal receives the second model parameter of the compression model corresponding to the decompression model sent by the network device, and directly uses the second model parameter to establish the compression model for compressing the channel state information. This enables the terminal to obtain the compression model by receiving the second model parameter sent by the network device when the terminal capability is insufficient.

It is worth noting that, when the model information includes the first model parameter of the decompression model and the second model parameters of the compression model corresponding to the decompression model, steps S402, S502, S602 to S603, and S702 in the above embodiments may be selectively executed according to the capability information of the terminal.

For example, if the current load of the terminal is higher than the first preset threshold, step S702 may be selected to be executed; if the current load of the terminal is lower than the second preset threshold, step S402 may be selected to be executed; if the current load of the terminal is higher than the second preset threshold but lower than the first preset threshold, steps S602 to S603 may be selected to be executed. Alternatively, when the current load of the terminal is lower than the second preset threshold and the computing power of the terminal is lower than the preset computing power threshold, steps S502 to S503 may be executed. The present disclosure does not specifically limit which method the terminal uses to obtain the compression model based on the model information sent by the network device.

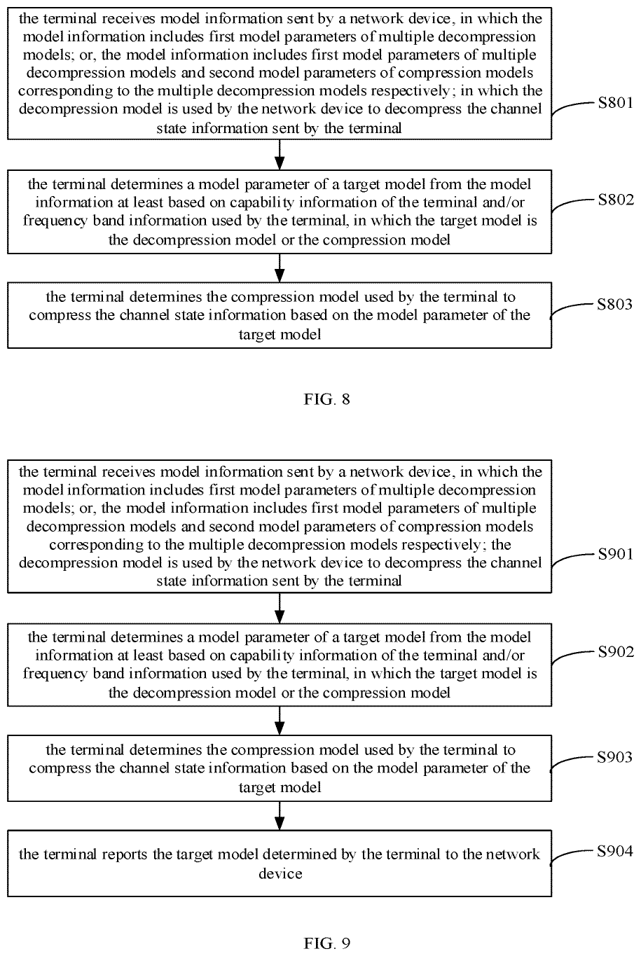

FIG. 8 is a flowchart of a method for determining a compression model for compressing channel state information according to an illustrative embodiment, which is applied to a terminal. As shown in FIG. 8, the method includes the following steps.
S801, the terminal receives model information sent by a network device, in which the model information includes first model parameters of multiple decompression models; or, the model information includes first model parameters of multiple decompression models and second model parameters of compression models corresponding to the multiple decompression models respectively; in which the decompression model is used by the network device to decompress the channel state information sent by the terminal.
S802, the terminal determines a model parameter of a target model from the model information at least based on capability information of the terminal and/or frequency band information used by the terminal, in which the target model is the decompression model or the compression model.
S803, the terminal determines the compression model used by the terminal to compress the channel state information based on the model parameter of the target model.

It is understandable that since the terminal manufacturers or chip manufacturers corresponding to the terminals connected to the network device may be completely different, the capabilities and adopted frequency bands of the terminals corresponding to different terminal manufacturers or chip manufacturers may also be completely different. Therefore, the network device may deploy multiple decompression models for terminals corresponding to different capabilities and frequency bands, thereby ensuring that the compressed channel state information sent by terminals with different capabilities and frequency bands may be reliably decompressed.

The model information includes first model parameters of multiple decompression models, or first model parameters of multiple decompression models and second model parameters of compression models corresponding to multiple decompression models, which may be determined according to capability information and/or frequency band information reported by the terminal. For example, if the capability information reported by the terminal indicates that the terminal does not have the ability to train the model, the network device may send model information including first model parameters of multiple decompression models and second model parameters of compression models corresponding to multiple decompression models.

In step S802, the terminal may determine the decompression model and/or compression model corresponding to the terminal based on the frequency band information used by the terminal, and then determine whether the target model is a decompression model or a compression model according to whether the terminal has the ability to train the compression model.

For example, when the model information only includes the first model parameters of the first decompression model corresponding to the first frequency band and the second decompression model corresponding to the second frequency band, if the frequency band information used by the terminal represents that the terminal uses the first frequency band, the target model may be determined to be the first decompression model.

For another example, when the model information includes first model parameters of a first decompression model corresponding to a first frequency band and second model parameters of a first compression model corresponding to the first decompression model, and first model parameters of a second decompression model corresponding to a second frequency band and second model parameters of a second compression model corresponding to the second decompression model, if the frequency band information used by the terminal indicates that the terminal uses the first frequency band, and the capability information of the terminal indicates that the terminal does not have the ability to train a compression model, it may be determined that the target model of the terminal is the first compression model.

Alternatively or additionally, if the target model is a decompression model, step S803 may be the compression model trained and obtained by the terminal according to the first model parameter corresponding to the decompression model, in which the compression model may be obtained by local training of the terminal or by training through a server. If the target model is a compression model, the terminal may determine, based on its capability information, whether the terminal directly establishes a compression model according to the second model parameter corresponding to the target model, or optimizes the second model parameter to obtain a third model parameter and establishes a compression model based on the third model parameter.

By adopting the above solution, the network device sends model parameters of multiple decompression models, or multiple decompression models and model parameters of compression models corresponding to the multiple decompression models, so that the terminal determines the target model according to its capability information and/or frequency band information, and determines the compression model of the terminal based on the parameters of the target model, thereby ensuring that the channel state information of terminals with different capabilities and frequency bands may be effectively compressed, and enabling the network terminal to reliably decompress the compressed channel state information sent by these terminals.

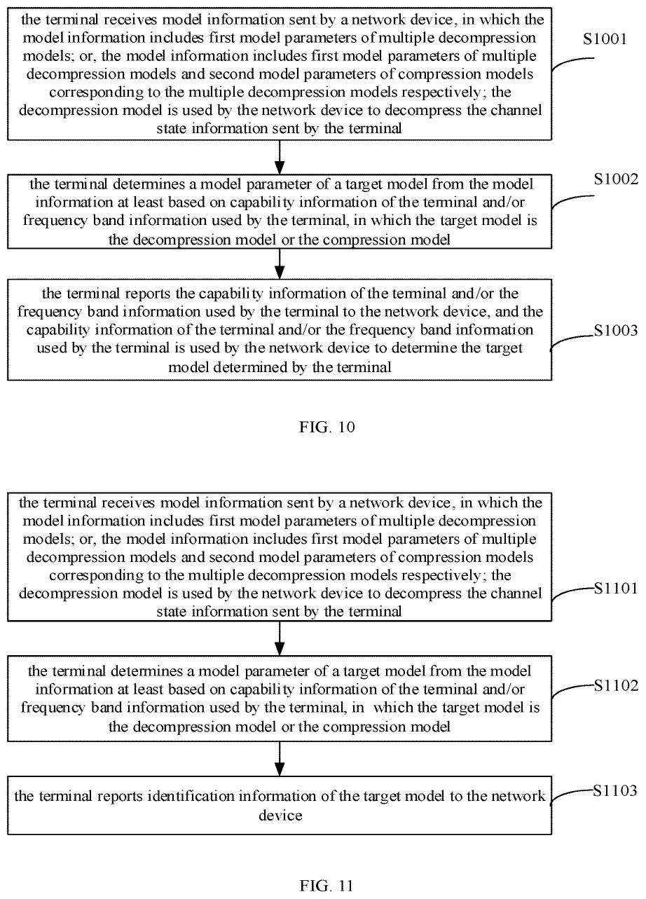

FIG. 9 is a flowchart of a method for determining a compression model for compressing channel state information according to an illustrative embodiment, which is applied to a terminal. As shown in FIG. 9, the method includes the following steps.
S901, the terminal receives model information sent by a network device, in which the model information includes first model parameters of multiple decompression models; or, the model information includes first model parameters of multiple decompression models and second model parameters of compression models corresponding to the multiple decompression models respectively; the decompression model is used by the network device to decompress the channel state information sent by the terminal.
S902, the terminal determines a model parameter of a target model from the model information at least based on capability information of the terminal and/or frequency band information used by the terminal, in which the target model is the decompression model or the compression model.
S903, the terminal determines the compression model used by the terminal to compress the channel state information based on the model parameter of the target model.
S904, the terminal reports the target model determined by the terminal to the network device.

It is worth noting that the above step S904 may be executed after step S903, or before step S903, or after step S902 and simultaneously with step S903, and the present disclosure does not limit this.

It should be noted that step S903 is to determine the model parameter of the target model from the model information through the capability information of the terminal and/or the frequency band information used by the terminal; of course, those skilled in the art may understand that the terminal may also determine the model parameter of the target model from the model information through other parameters, which will not be repeated here.

By adopting the above solution, after determining the target model, the target model determined by the terminal is reported to the network device, so that after receiving the target model reported by the terminal, the network device may determine the decompression model corresponding to the channel state information sent by the terminal according to the target model, so that the network device may correctly select to use the decompression model and the compression model in the terminal together to ensure that the channel state information sent by the terminal may be effectively decompressed.

FIG. 10 is a flowchart of a method for determining a compression model for compressing channel state information according to an illustrative embodiment, which is applied to a terminal. As shown in FIG. 10, the method includes the following steps.
S1001, the terminal receives model information sent by a network device, in which the model information includes first model parameters of multiple decompression models; or, the model information includes first model parameters of multiple decompression models and second model parameters of compression models corresponding to the multiple decompression models respectively; the decompression model is used by the network device to decompress the channel state information sent by the terminal.
S1002, the terminal determines a model parameter of a target model from the model information at least based on capability information of the terminal and/or frequency band information used by the terminal, in which the target model is the decompression model or the compression model.
S1003, the terminal reports the capability information of the terminal and/or the frequency band information used by the terminal to the network device, and the capability information of the terminal and/or the frequency band information used by the terminal is used by the network device to determine the target model determined by the terminal.

For example, when the model information only includes the first model parameters of the first decompression model corresponding to the first frequency band and the second decompression model corresponding to the second frequency band, if the network device determines that the frequency band information indicates that the terminal is using the first frequency band based on the frequency band information reported by the terminal, then the network device may determine that the first decompression model selected by the terminal is the target model.

For another example, when the model information includes a first model parameter of a first decompression model corresponding to a first frequency band and a second model parameter of a first compression model corresponding to the first decompression model, and a first model parameter of a second decompression model corresponding to a second frequency band and a second model parameter of a second compression model corresponding to the second decompression model, if the network device determines that the frequency band information indicates that the terminal uses the first frequency band based on the frequency band information reported by the terminal, and the capability information reported by the terminal indicates that the terminal does not have the ability to train a compression model, it may be determined that the target model selected by the terminal is the first compression model.

Furthermore, the network device may determine a decompression model for decompressing the channel state information sent by the terminal according to the target model selected by the terminal to decompress the channel state information.

It should be noted that step S1002 is to determine the model parameter of the target model from the model information through the capability information of the terminal and/or the frequency band information used by the terminal; of course, those skilled in the art may understand that the terminal may also determine the model parameter of the target model from the model information through other parameters, which will not be repeated here.

By adopting the above solution, after determining the target model, the capability information of the terminal and/or the frequency band information used by the terminal is reported to the network device, so that the network device may determine the target model determined by the terminal. After receiving the target model reported by the terminal, the network device may determine the decompression model corresponding to the channel state information sent by the terminal according to the target model, so as to ensure that the channel state information sent by the terminal may be effectively decompressed.

FIG. 11 is a flowchart of a method for determining a compression model for compressing channel state information according to an illustrative embodiment, which is applied to a terminal. As shown in FIG. 11, the method includes the following steps.
S1101, the terminal receives model information sent by a network device, in which the model information includes first model parameters of multiple decompression models; or, the model information includes first model parameters of multiple decompression models and second model parameters of compression models corresponding to the multiple decompression models respectively; the decompression model is used by the network device to decompress the channel state information sent by the terminal.
S1102, the terminal determines a model parameter of a target model from the model information at least based on capability information of the terminal and/or frequency band information used by the terminal, in which the target model is the decompression model or the compression model.
S1103, the terminal reports identification information of the target model to the network device.

It may be understood that the identification information is used to uniquely identify each decompression model in the model information.

For each group of decompression model and compression model used together, the same identification information may be used, or different identification information may be used, and the identification information may be represented by a model ID. For example, for a first decompression model and a first compression model corresponding to the first decompression model, “0001” may be used as the corresponding identification information, or, for the first decompression model, “0010” may be used as the corresponding identification information, and for the first compression model, “0011” may be used as the corresponding identification information. The present disclosure does not limit the setting method of the identification information.

It should be noted that step S1102 is to determine the model parameter of the target model from the model information through the capability information of the terminal and/or the frequency band information used by the terminal; of course, those skilled in the art may understand that the terminal may also determine the model parameter of the target model from the model information through other parameters, which will not be repeated here.

By adopting the above solution, after determining the target model, the identification information of the target model is reported to the network device, so that the network device may determine the target model determined by the terminal. After the network device determines the target model reported by the terminal, the decompression model corresponding to the channel state information sent by the terminal may be determined according to the target model to ensure that the channel state information sent by the terminal may be effectively decompressed.

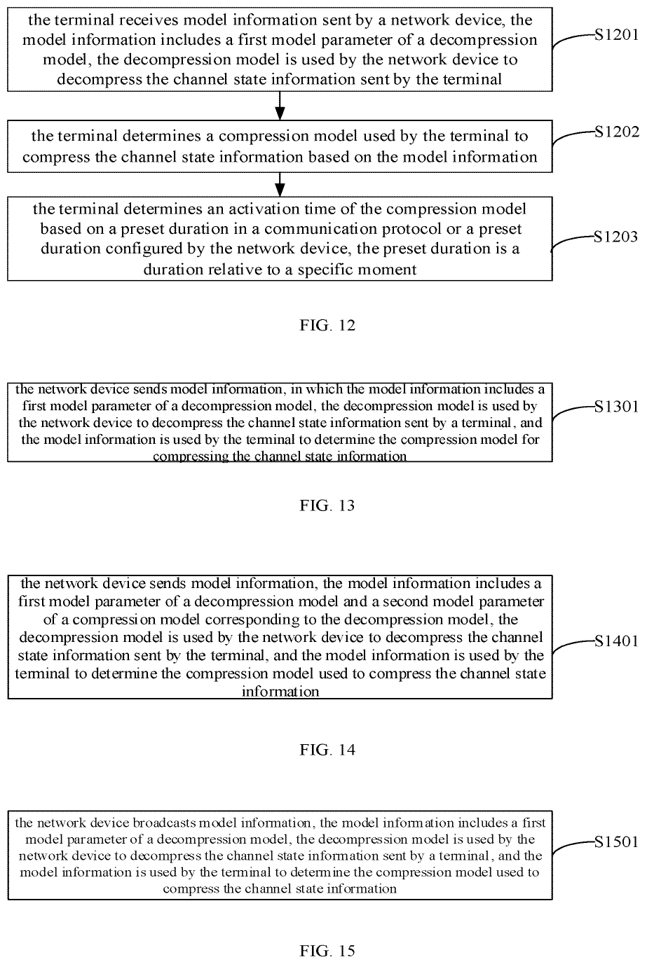

FIG. 12 is a flowchart of a method for determining a compression model for compressing channel state information according to an illustrative embodiment, which is applied to a terminal. As shown in FIG. 12, the method includes the following steps.
S1201, the terminal receives model information sent by a network device. The model information includes a first model parameter of a decompression model. The decompression model is used by the network device to decompress the channel state information sent by the terminal.
S1202, the terminal determines a compression model used by the terminal to compress the channel state information based on the model information.
S1203, the terminal determines an activation time of the compression model based on a preset duration in a communication protocol or a preset duration configured by the network device, in which the preset duration is a duration relative to a specific moment.

The preset duration configured by the network device may be sent to the terminal via model information, or may be sent to the terminal via other signaling.

It may be understood that the communication protocol is a pre-defined protocol for communication between the terminal and the network device. The network device may also determine the compression model of the terminal and the activation time of its own decompression model based on the preset duration in the communication protocol or the preset duration configured by the network device.

In an example, the specific moment is an end moment when the terminal finishes receiving a physical downlink shared channel (PDSCH) containing the model information.

In another example, the specific moment is a moment when the terminal feeds back a last symbol of an uplink resource for hybrid automatic repeat request-acknowledgement (HARQ-ACK) information of the PDSCH including the model information.

The preset duration may be determined in different ways for different compression models.

For example, in the compression model determination method corresponding to step S402 and step S502 in the above embodiment, the preset duration may be X unit durations; in the compression model determination method corresponding to step S602 to step S603 in the above embodiment, the preset duration may be Y unit durations; in the compression model determination method corresponding to step S702 in the above embodiment, the preset duration may be Z unit durations, and the sizes of X, Y, and Z may be specified in the communication protocol or configured by the network device. X may be greater than Y and Y may be greater than Z, or X, Y, and Z may be equal, and the present disclosure does not limit this.

The unit duration may be a duration corresponding to a time slot, a duration corresponding to a symbol, or a duration corresponding to a sub-frame, and the present disclosure does not limit it.

For example, if the end moment when the terminal finishes receiving a physical downlink shared channel (PDSCH) containing the model information is the moment corresponding to slot n, the unit duration is the time slot, slot represents the time slot and n is the number of the time slot. If the terminal adopts the compression model determination method of steps S402 to S403, the activation time of the compression model may be the moment corresponding to slot n+X, that is, the compression model is activated at the moment corresponding to the time slot numbered n+X.

By adopting the above solution, by stipulating the preset duration in the communication protocol or configuring the preset duration in the network device, and determining the activation time for the terminal to activate the compression model based on the specific moment corresponding to the model information, the terminal and the network device may synchronously activate the compression model and the decompression model, thereby ensuring that the network device may reliably decompress the compressed channel state information sent by the terminal, so as to ensure the communication quality between the network device and the terminal.

It should be noted that the aforementioned embodiments executed by the terminal may be implemented separately or in combination, and the embodiments of the present disclosure are not limited to this.

FIG. 13 is a flow chart of a method for determining a compression model for compressing channel state information according to an illustrative embodiment, which is applied to a network device. As shown in FIG. 13, the method includes the following steps.
S1301, the network device sends model information, in which the model information includes a first model parameter of a decompression model, the decompression model is used by the network device to decompress the channel state information sent by a terminal, and the model information is used by the terminal to determine the compression model for compressing the channel state information.

In an example, the model information may also include first model parameters of multiple decompression models; or, the model information includes first model parameters of multiple decompression models and second model parameters of compression models corresponding the multiple decompression models respectively.

In an example, the model information may be sent by a base station via an RRC signaling, in which case the network device may be a base station. Alternatively, in another example, the model information may be sent by an AMF in a core network, i.e., an access and mobility management entity, via a Non-access stratum (NAS) layer signaling, in which case the network device may be an AMF.

In another example, the compression model used by the terminal to compress the channel state information satisfies at least one of the following model performance conditions: a mean square error or a normalized mean square error being less than a first preset threshold in a case that the compression model and the decompression model are used together; a cosine similarity being greater than a second preset threshold in a case that the compression model and the decompression model are used together; a square of the cosine similarity being greater than a third preset threshold in a case that the compression model and the decompression model are used together; or a signal-to-noise ratio being greater than a fourth preset threshold in a case that the compression model and the decompression model are used together.

In step S1301, the model information may be sent when a decompression model deployed in the network device is changed, or may be sent in response to a terminal connecting to a base station.

It is worth noting that the network device sends model information so that the terminal determines the compression model used to compress the channel state information, which may ensure that the network device has the dominant position of the compression model of the terminal. When the decompression model deployed on the network device is updated, the compression model deployed on the terminal may be effectively updated.

In an example, a preset duration may be configured in the network device, or a preset duration may be specified in the communication protocol between the network device and the terminal, so that the terminal determines the activation time of the compression model according to the preset duration. Furthermore, the network device may determine the activation time of the decompression model corresponding to the compression model used by the terminal according to the preset duration. The preset duration is a duration relative to a specific moment. This allows the terminal and the network device to synchronously activate the corresponding compression model and decompression model to achieve reliable compression and decompression of the channel state information.

In an embodiment of the present disclosure, the model information is sent to the terminal through the network device, so that the terminal obtains the compression model of the compressed channel state information according to the model information. Since the model information includes the first model parameter of the decompression model of the network device, the terminal may obtain the compression model for use in conjunction with the decompression model of the network device according to the first model parameter and the privatized data of the terminal manufacturer or chip manufacturer. In this process, the network device does not need to know the parameters of the compression model deployed by the terminal, thereby ensuring the privatization of the compression model.

FIG. 14 is a flow chart showing a method for determining a compression model for compressing channel state information according to an illustrative embodiment, which is applied to a network device. As shown in FIG. 14, the method includes the following steps.
S1401, the network device sends model information, the model information includes a first model parameter of a decompression model and a second model parameter of a compression model corresponding to the decompression model. The decompression model is used by the network device to decompress the channel state information sent by the terminal, and the model information is used by the terminal to determine the compression model used to compress the channel state information.

Whether the network device sends the second model parameter may be determined according to the capability information reported by the terminal or the terminal group. In addition, after receiving the model information, the terminal may determine whether to use the first model parameter to determine the decompression model or to use the second model parameter to determine the compression model according to its own capabilities or other parameters. In addition, after receiving the model information, the terminal may determine whether to use the second model parameter to determine the compression model or to use the second model parameter to optimize and obtain the third model parameter, and establish the compression model for compressing the channel state information based on the third model parameter.

By adopting the above solution, by sending the first model parameter and the second model parameter to the terminal, the terminal with model training capability may obtain the compression model according to the first model parameters, the terminal without model training capability may also obtain the compression model according to the second model parameters, which may ensure that terminals of different terminal manufacturers or terminal chip manufacturers may effectively obtain the compression model.

FIG. 15 is a flow chart of a method for determining a compression model for compressing channel state information according to an illustrative embodiment, which is applied to a network device. As shown in FIG. 15, the method includes the following steps.
S1501, the network device broadcasts model information, the model information includes a first model parameter of a decompression model. The decompression model is used by the network device to decompress the channel state information sent by a terminal. The model information is used by the terminal to determine the compression model used to compress the channel state information.

In an example, the model information may also include a second model parameter of the compression model corresponding to the decompression model.

In another example, the model information may also include first model parameters of multiple decompression models; or, the model information includes first model parameters of multiple decompression models and second model parameters of compression models corresponding to the multiple decompression models respectively.

By adopting the above solution, the network device sends the model information by broadcasting, so that all terminals within the broadcast range may receive the model information, and then determine the compression model for compressing the channel state information according to the model information.

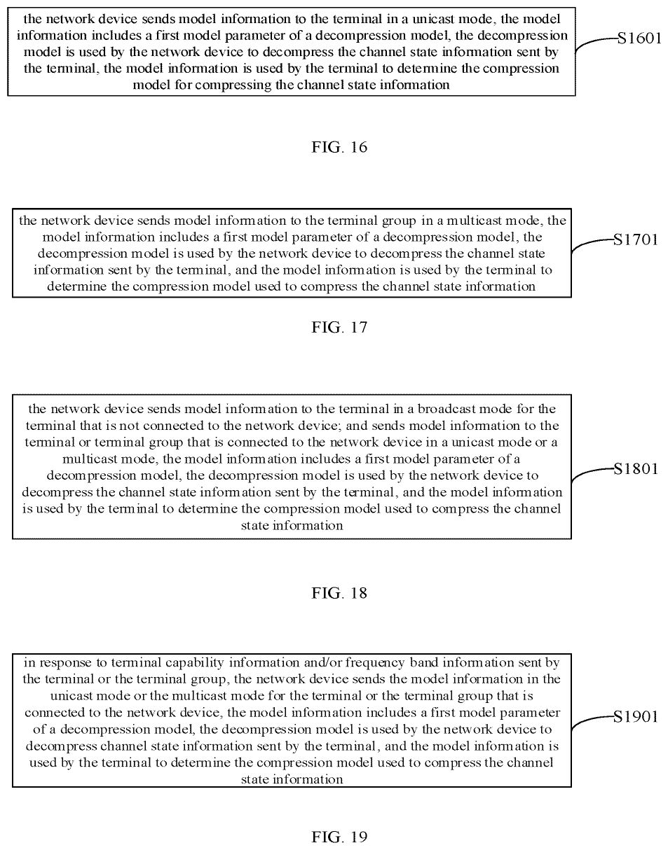

FIG. 16 is a flow chart of a method for determining a compression model for compressing channel state information according to an illustrative embodiment, which is applied to a network device. As shown in FIG. 16, the method includes the following steps.
S1601, the network device sends model information to the terminal in a unicast mode. The model information includes a first model parameter of a decompression model. The decompression model is used by the network device to decompress the channel state information sent by the terminal. The model information is used by the terminal to determine the compression model for compressing the channel state information.

It is understandable that the model information sent via a unicast mode may be different for different terminals. For example, for a first terminal, first model information may be sent to the first terminal via a unicast mode, and for a second terminal, second model information may be sent to the second terminal via a unicast mode.

In an example, the model information may also include a second model parameter of the compression model corresponding to the decompression model.

In another example, the model information may also include first model parameters of multiple decompression models; or, the model information includes first model parameters of multiple decompression models and second model parameters of compression models corresponding to the multiple decompression models respectively.

By adopting the above solution, the model information is sent to the terminal in a unicast mode, so that the model information may be sent more specifically, and the network resources may be prevented from being over-occupied due to excessive redundant information in the sent information, thereby effectively improving the utilization rate of network resources.

FIG. 17 is a flow chart of a method for determining a compression model for compressing channel state information according to an illustrative embodiment, which is applied to a network device. As shown in FIG. 17, the method includes the following steps.
S1701, the network device sends model information to the terminal group in a multicast mode. The model information includes a first model parameter of a decompression model. The decompression model is used by the network device to decompress the channel state information sent by the terminal. The model information is used by the terminal to determine the compression model used to compress the channel state information.

It is understandable that the model information sent via a multicast mode may be different for different terminal groups. For example, for a first terminal group, first model information may be sent to a terminal in the first terminal group via a multicast mode, and for a second terminal group, second model information may be sent to a terminal in the second terminal group via a multicast mode.

In an example, the model information may also include a second model parameter of the compression model corresponding to the decompression model.

In another example, the model information may also include first model parameters of multiple decompression models; or, the model information includes first model parameters of multiple decompression models and second model parameters of compression models corresponding to the multiple decompression models respectively.

By adopting the above solution, model information is sent to the terminal group via a multicast mode, so that the model information may be sent more specifically, and the network resources may be prevented from being over-occupied due to excessive redundant information in the sent information, thereby effectively improving the utilization rate of network resources.

FIG. 18 is a flow chart of a method for determining a compression model for compressing channel state information according to an illustrative embodiment, which is applied to a network device. As shown in FIG. 18, the method includes the following steps.
S1801, the network device sends model information to the terminal in a broadcast mode for the terminal that is not connected to the network device; and sends model information to the terminal or terminal group that is connected to the network device in a unicast mode or a multicast mode. The model information includes a first model parameter of a decompression model. The decompression model is used by the network device to decompress the channel state information sent by the terminal. The model information is used by the terminal to determine the compression model used to compress the channel state information.

The model information sent in a broadcast mode may be different from the model information sent in a unicast or multicast mode. For example, the model information sent in a broadcast mode may include the first model parameters corresponding to all decompression models deployed in the network device. The model information sent in a unicast or multicast mode may only include the first model parameters corresponding to some decompression models deployed in the network device.

In an example, the model information may also include a second model parameter of the compression model corresponding to the decompression model.

In another example, the model information may also include first model parameters of multiple decompression models; or, the model information includes first model parameters of multiple decompression models and second model parameters of compression models corresponding to the multiple decompression models respectively.

By adopting the above solution, for terminals that are not connected to the network device, the model information may be received by all terminals within the broadcast range in a broadcast mode, and then the compression model used to compress the channel state information may be determined according to the model information, which may ensure that all terminals within the broadcast range may obtain the corresponding compression model according to the model information to communicate with the network device. For terminals that have been connected to the network, the model information may be sent more specifically in a unicast or multicast mode, and the network resources may be prevented from being over-occupied due to excessive redundant information in the sent information, thereby effectively improving the utilization rate of network resources.

FIG. 19 is a flow chart of a method for determining a compression model for compressing channel state information according to an illustrative embodiment, which is applied to a network device. As shown in FIG. 19, the method includes the following steps.
S1901, in response to terminal capability information and/or frequency band information sent by the terminal or the terminal group, the network device sends the model information in the unicast mode or the multicast mode for the terminal or the terminal group that is connected to the network device. The model information includes a first model parameter of a decompression model. The decompression model is used by the network device to decompress channel state information sent by the terminal. The model information is used by the terminal to determine the compression model used to compress the channel state information.

In an example, for terminals or terminal groups with different terminal capability information and/or used frequency band information, the model information sent by the network device are different.

For example, if the terminal frequency band information received from the terminal group indicates that the terminals in the terminal group use the first frequency band, and the capability information indicates that the terminals have the ability to train the compression model, model information including the first model parameters of the decompression model corresponding to the first frequency band may be sent to the terminal group in a multicast mode. Furthermore, if the capability information indicates that the current load of a terminal in the terminal group is too high to perform model training, the model information sent in a multicast mode may also include the second model parameter of the compression model corresponding to the decompression model corresponding to the first frequency band, so that the terminal may optimize and obtain the compression model based on the second model parameter.

In another example, if the frequency band information received from the terminal group indicates that all terminals in the terminal group use the second frequency band, model information may be sent to the terminal group in a multicast mode, and the model information includes the first model parameter of the decompression model corresponding to the second frequency band. Alternatively, if the frequency band information indicates that the terminals in the terminal group use the first frequency band and the second frequency band, model information may be sent to the terminal group in a multicast mode, and the model information includes the first model parameter of the decompression model corresponding to the first frequency band, and the first model parameter of the decompression model corresponding to the first frequency band.

In another example, if the frequency band information received from the terminal indicates that the terminal uses the second frequency band, and the capability information indicates that the terminal does not currently have the ability to train the model, then model information including the first model parameter of the decompression model corresponding to the second frequency band and the second model parameter of the compression model corresponding to the decompression model may be sent to the terminal in a unicast mode.

In an example, the model information may also include a second model parameter of the compression model corresponding to the decompression model.

In another example, the model information may also include first model parameters of multiple decompression models; or, the model information includes first model parameters of multiple decompression models and second model parameters of compression models corresponding to the multiple decompression models respectively.

By adopting the above solution, the network device receives the capability information and/or frequency band information of the terminal or terminal group that has been connected to the network device, and sends the model information in a unicast or multicast mode. The model information may be sent more specifically according to the capability of the terminal or terminal group and the frequency band used by the terminal or terminal group, and the communication resources may be prevented from being over-occupied due to excessive redundant information in the sent information, thereby effectively improving the utilization rate of communication resources.

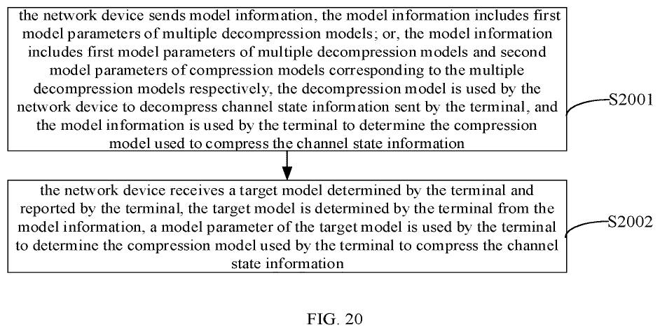

FIG. 20 is a flowchart of a method for determining a compression model for compressing channel state information according to an illustrative embodiment, which is applied to a network device. As shown in FIG. 20, the method includes the following steps.
S2001, the network device sends model information, the model information includes first model parameters of multiple decompression models; or, the model information includes first model parameters of multiple decompression models and second model parameters of compression models corresponding to the multiple decompression models respectively. The decompression model is used by the network device to decompress channel state information sent by the terminal, and the model information is used by the terminal to determine the compression model used to compress the channel state information.
S2002, the network device receives a target model determined by the terminal and reported by the terminal. The target model is determined by the terminal from the model information. A model parameter of the target model is used by the terminal to determine the compression model used by the terminal to compress the channel state information.

It may be understood that, when the model information includes the first model parameters of multiple decompression models; or, when the model information includes the first model parameters of multiple decompression models and the second model parameters of the compression model corresponding to the multiple decompression models respectively, the terminal will only select the model parameters corresponding to one of the decompression model or the compression model to obtain the compression model. Therefore, if the network device and the terminal need to jointly use the corresponding compression model and decompression model, it is necessary to determine the target model selected by the terminal to ensure that the network device may effectively decompress the channel state information.

In an example, the terminal may report identification information of the target model so that the network device determines the target model determined by the terminal according to the identification information.

In another example, the terminal may report the capability information of the terminal and/or the frequency band information used by the terminal, so that the network device determines the target model determined by the terminal according to the capability information and/or the frequency band information.

By adopting the above solution, the network device may receive the target model selected and reported by the terminal, so that when the network device receives the compressed channel state information sent by the terminal, it may determine the decompression model corresponding to the compression model used by the terminal to decompress the channel state information, thereby effectively ensuring the communication quality between the terminal and the network device.

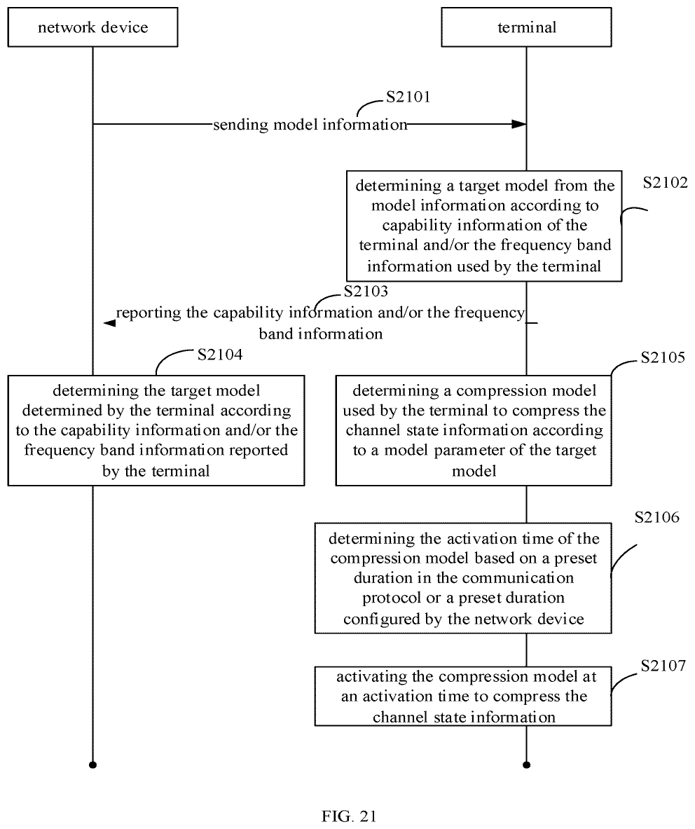

FIG. 21 is an interaction diagram of a method for determining a compression model for compressing channel state information according to an illustrative embodiment. As shown in FIG. 21, the method includes the following steps.
S2101, the network device sends model information to a terminal.

The model information may include first model parameters of multiple decompression models; or, the model information may include first model parameters of multiple decompression models and second model parameters of compression models corresponding to the multiple decompression models respectively.

The model information may be sent in a multicast mode, the terminal is one terminal in the terminal group, or may be sent in a broadcast mode.
S2102, the terminal determines a target model from the model information according to capability information of the terminal and/or the frequency band information used by the terminal.
S2103, the terminal reports the capability information and/or the frequency band information to the network device.
S2104, the network device determines the target model determined by the terminal according to the capability information and/or the frequency band information reported by the terminal.

In some other optional embodiments, in step S2103, the terminal may report identification information of the target model determined by the terminal, so that the network device determines the target model determined by the terminal based on the identification information.
S2105, the terminal determines a compression model used by the terminal to compress the channel state information according to a model parameter of the target model.

The target model may be a compression model or a decompression model.

When the target model is a decompression model, the terminal may train and obtain the compression model based on the first model parameter of the decompression model, the step of training the compression model may be executed by the server.

When the target model is a compression model, the terminal may directly apply the second model parameter corresponding to the compression model, or the terminal may also optimize the second model parameter and apply the same, that is, establish the compression model based on a third model parameter obtained by optimizing the second model parameter.

It may be understood that whether to train the compression model on the terminal or through the server may be determined based on the capability information of the terminal. For example, if the terminal is currently too loaded to train locally, a model obtaining request may be sent to the server to obtain the compression model trained on the server.

Similarly, directly applying the second model parameter of the compression model corresponding to the target model, or constructing the compression model after optimizing the second model, may also be determined according to the capability information of the terminal.
S2106, the activation time of the compression model is determined based on a preset duration in the communication protocol or a preset duration configured by the network device.

The preset duration may be a duration relative to a specific moment, and the specific moment includes an end moment when the terminal finishes receiving a PDSCH containing the model information, and/or a moment when the terminal feeds back a last symbol of an uplink resource for HARQ-ACK information of the PDSCH including the model information.
S2107, the compression model is activated at an activation time to compress the channel state information.

It is understandable that the network device may synchronously activate the decompression model corresponding to the compression model at the activation time. Alternatively, the decompression model remains activated in the network device, and the network device may determine the decompression model corresponding to the compressed channel state information received from the terminal to decompress the compressed channel state information.

It should be noted that the aforementioned embodiments executed by the network device may be implemented individually or in combination, and the embodiments of the present disclosure are not limited to this.

Those skilled in the art may understand that the aforementioned multiple embodiments executed by the terminal and the multiple embodiments executed by the network device correspond to each other, so the corresponding steps may be described only on one side, and the other side must perform the corresponding operation. For example, the network device broadcasts the model information or sends the model information to the terminal by a unicast mode or sends the model information to the terminal group in a multicast mode; then the terminal will inevitably receive the model information in a corresponding mode.

The following is a description of the device according to an embodiment of the present disclosure. It should be noted that the functions of each module have been described in detail in an embodiment of the method and will not be elaborated here.

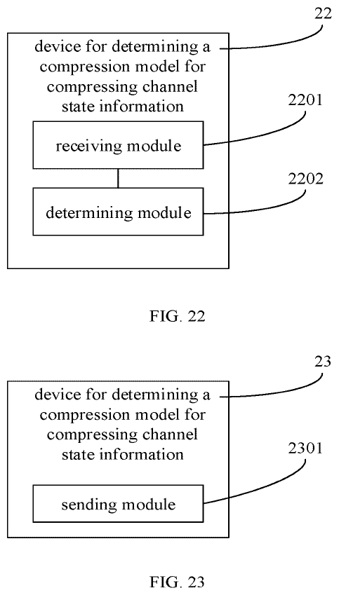

FIG. 22 is a block diagram of a device 22 for determining a compression model for compressing channel state information according to an embodiment. The device 22 is applied to a terminal, and the device 22 includes the following modules.

A receiving module 2201 is configured to receive model information sent by a network device, the model information includes a first model parameter of a decompression model, and the decompression model is used by the network device to decompress the channel state information sent by the terminal;

A determining module 2202 is configured to determine the compression model used by the terminal to compress the channel state information based on the model information.

In some examples, the model information also includes a second model parameter of the compression model corresponding to the decompression model.

In some examples, the determining module 2202 includes:
a training sub-module, configured to train and obtain the compression model corresponding to the decompression model based on the first model parameter.

In some examples, the determining module 2202 includes:
a local training module, configured to train and obtain the compression model corresponding to the decompression model locally by the terminal;
a server training module, configured to send an obtaining request to a server, and obtaining the compression model corresponding to the decompression model sent by the server.

In some examples, the determining module 2202 includes:
an optimizing sub-module, configured to optimize the second model parameters to obtain a third model parameter;
a first establishing sub-module, configured to establish the compression model for compressing the channel state information based on the third model parameter.

In some examples, the determining module 2202 includes:
a second establishing sub-module, configured to establish the compression model for compressing the channel state information based on the second model parameter.

In some examples, the compression model used by the terminal to compress the channel state information satisfies at least one of model performance conditions:
a mean square error or a normalized mean square error being less than a first preset threshold in a case that the compression model and the decompression model are used together;
a cosine similarity being greater than a second preset threshold in a case that the compression model and the decompression model are used together;
a square of the cosine similarity being greater than a third preset threshold in a case that the compression model and the decompression model are used together; or
a signal-to-noise ratio being greater than a fourth preset threshold in a case that the compression model and the decompression model are used together.

In some examples, the model information include first model parameters of a plurality of decompression models; or, the model information includes the first model parameters of the plurality of decompression models and second model parameters of compression models corresponding to the plurality of decompression models respectively.

In some examples, the determining module 2202 includes:
a first determining sub-module, configured to determine a model parameter of a target model from the model information at least based on capability information of the terminal and/or frequency band information used by the terminal, in which the target model is the decompression model or the compression model;
a second determining sub-module, configured to determine the compression model used by the terminal to compress the channel state information based on the model parameter of the target model.

In some examples, the device 22 further includes:
a reporting module, configured to report the target model determined by the terminal to the network device.

In some examples, the reporting module includes:
a first reporting sub-module, configured to report identification information of the target model to the network device;
a second reporting sub-module, configured to report the capability information of the terminal and/or the frequency band information used by the terminal to the network device, in which the capability information of the terminal and/or the frequency band information used by the terminal is used by the network device to determine the target model determined by the terminal.

In some examples, the device 22 further includes:
an activation module, configured to determine an activation time of the compression model based on a preset duration in a communication protocol or a preset duration configured by the network device, in which the preset duration is a duration relative to a specific moment.

In some examples, the specific moment includes an end moment when the terminal finishes receiving a PDSCH containing the model information, and/or a moment when the terminal feeds back a last symbol of an uplink resource for HARQ-ACK information of the PDSCH comprising the model information.

FIG. 23 is a block diagram of a device 23 for determining a compression model for compressing channel state information according to an embodiment. The device 23 is applied to a network device, and the device 23 includes the following modules.

The sending module 2301 is configured to send model information, the model information include a first model parameter of a decompression model, the decompression model is used by the network device to decompress the channel state information sent by a terminal, and the model information is used by the terminal to determine the compression model for compressing the channel state information.

In some examples, the model information also includes a second model parameter of the compression model corresponding to the decompression model.

In some examples, the sending module 2301 includes:
a first broadcast sub-module, configured to broadcast the model information; or,
a unicast sub-module, configured to send the model information to the terminal in a unicast mode; or,
a multicast sub-module, configured to send the model information to the terminal group in a multicast mode.

In some examples, the sending module 2301 includes:
a second sending sub-module, configured to send the model information in a broadcast mode for a terminal that is not connected to the network device;
a second sending sub-module, configured to send the model information in a unicast mode or a multicast mode for a terminal or a terminal group that is connected to the network device.

In some examples, the second sending sub-module includes:
a third sending sub-module, configured to, in response to terminal capability information and/or frequency band information sent by the terminal or the terminal group, send the model information in the unicast mode or the multicast mode for the terminal or the terminal group that is connected to the network device.

In some examples, model information sent by the network device are different for terminals or terminal groups with different terminal capability information and/or different frequency band information.

In some examples, the model information include first model parameters of a plurality of decompression models; or, the model information includes first model parameters of the plurality of decompression models and second model parameters of compression models corresponding to the plurality of decompression models respectively.

In some examples, the device 23 further includes:
a first receiving module, configured to receive a target model determined and reported by the terminal, in which the target model is determined by the terminal from the model information, and a model parameter of the target model is used by the terminal to determine the compression model for compressing the channel state information.

In some examples, the network device is a base station, and the sending module 2301 includes:
an RRC signaling sending module, configured to send the model information via an RRC signaling.

In some examples, the network device is an AMF network element in the core network, and the sending module 2301 includes:
an NAS signaling sending module, configured to send the model information via an NAS signaling.

Regarding the device in the above embodiment, the specific manner in which each module performs operations has been described in detail in an embodiment of the method, and will not be elaborated here.

The present disclosure also provides a computer readable storage medium having computer program instructions stored thereon, when executed by a processor, the steps of a method for determining a compression model for compressing channel state information provided by any of the aforementioned method embodiments of the present disclosure are performed.

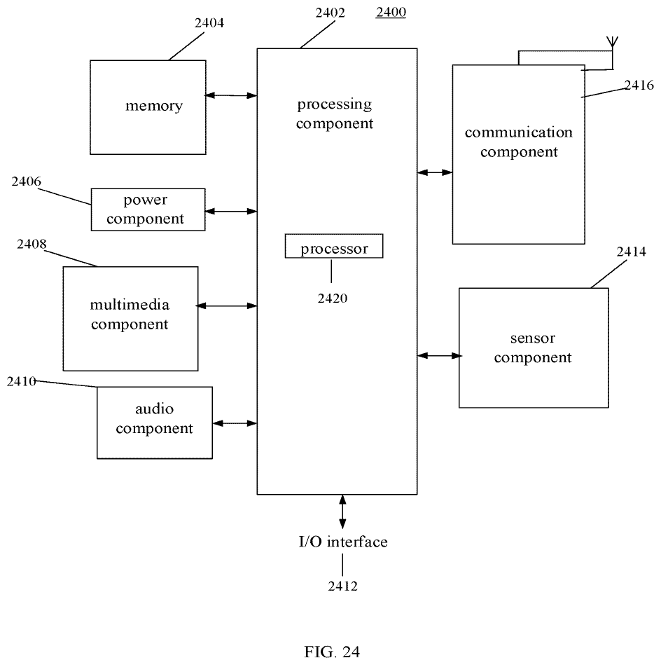

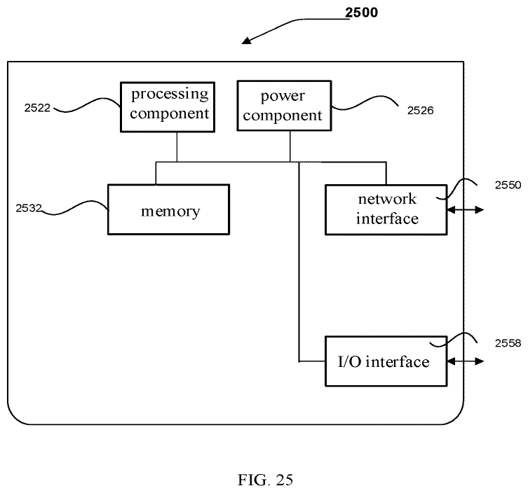

FIG. 24 is a block diagram of a terminal 2400 according to an embodiment. For example, the terminal 2400 may be a mobile phone, a computer, a digital broadcast terminal, a messaging device, a game console, a tablet device, a medical device, a fitness device, a personal digital assistant, etc.

As shown in FIG. 24, terminal 2400 may include one or more of the following components: a processing component 2402, a memory 2404, a power component 2406, a multimedia component 2408, an audio component 2410, an input/output (I/O) interface 2412, a sensor component 2414, and a communication component 2416.

The processing component 2402 generally controls the overall operation of the terminal 2400, such as operations associated with display, phone calls, data communications, camera operations, and recording operations. The processing component 2402 may include one or more processors 2420 to execute instructions to complete all or part of the steps of the above-mentioned method. In addition, the processing component 2402 may include one or more modules to facilitate the interaction between the processing component 2402 and other components. For example, the processing component 2402 may include a multimedia module to facilitate the interaction between the multimedia component 2408 and the processing component 2402.

The memory 2404 is configured to store various types of data to support operations at the terminal 2400. Examples of such data include instructions for any application or method operating on the terminal 2400, contact data, phone book data, messages, pictures, videos, etc. The memory 2404 may be implemented by any type of volatile or non-volatile storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk, or optical disk.

Power component 2406 provides power to various components of terminal 2400. Power component 2406 may include a power management system, one or more power supplies, and other components associated with generating, managing, and distributing power to terminal 2400.

The multimedia component 2408 includes a screen that provides an output interface between the terminal 2400 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touch, slide, and gestures on the touch panel. The touch sensor may not only sense the boundaries of the touch or slide action, but also detect the duration and pressure associated with the touch or slide operation. In some embodiments, the multimedia component 2408 includes a front camera and/or a rear camera. When the terminal 2400 is in an operating mode, such as a shooting mode or a video mode, the front camera and/or the rear camera may receive external multimedia data. Each front camera and rear camera may be a fixed optical lens system or have a focal length and optical zoom capability.

The audio component 2410 is configured to output and/or input audio signals. For example, the audio component 2410 includes a microphone (MIC), and when the terminal 2400 is in an operation mode, such as a call mode, a recording mode, and a speech recognition mode, the microphone is configured to receive an external audio signal. The received audio signal may be further stored in the memory 2404 or sent via the communication component 2416. In some embodiments, the audio component 2410 also includes a speaker for outputting audio signals.

I/O interface 2412 provides an interface between a processing component 2402 and a peripheral interface module, the peripheral interface module may be keyboards, click wheels, buttons, etc. These buttons may include, but are not limited to, home buttons, volume buttons, start buttons, and lock buttons.

The sensor assembly 2414 includes one or more sensors for providing various aspects of status assessment for the terminal 2400. For example, the sensor assembly 2414 may detect the on/off state of the terminal 2400, the relative positioning of the components, such as the display and keypad of the terminal 2400, and the sensor assembly 2414 may also detect the position change of the terminal 2400 or a component of the terminal 2400, the presence or absence of contact between the user and the terminal 2400, the orientation or acceleration/deceleration of the terminal 2400, and the temperature change of the terminal 2400. The sensor assembly 2414 may include a proximity sensor configured to detect the presence of a nearby object without any physical contact. The sensor assembly 2414 may also include an optical sensor, such as a CMOS or CCD image sensor, for use in imaging applications. In some embodiments, the sensor assembly 2414 may also include an acceleration sensor, a gyroscope sensor, a magnetic sensor, a pressure sensor, or a temperature sensor.

The communication component 2416 is configured to facilitate wired or wireless communication between the terminal 2400 and other devices. The terminal 2400 may access a wireless network based on a communication standard, such as WiFi, 2G or 3G, or a combination thereof. In an illustrative embodiment, the communication component 2416 receives a broadcast signal or broadcast-related information from an external broadcast management system via a broadcast channel. In an illustrative embodiment, the communication component 2416 also includes a near field communication (NFC) module to facilitate short-range communication. For example, the NFC module may be implemented based on radio frequency identification (RFID) technology, infrared data association (IrDA) technology, ultra-wideband (UWB) technology, Bluetooth (BT) technology and other technologies.

In an illustrative embodiment, terminal 2400 may be implemented by one or more application-specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components to perform the above methods.

In an illustrative embodiment, a non-transitory computer readable storage medium including instructions is also provided, such as a memory 2404 including instructions, and the instructions may be executed by a processor 2420 of a terminal 2400 to perform the above method. For example, the non-transitory computer readable storage medium may be a ROM, a random access memory (RAM), a CD-ROM, a magnetic tape, a floppy disk, an optical data storage device, etc.

In another illustrative embodiment, a computer program product is also provided, which includes a computer program executable by a programmable device, and has a code portion for executing the above-mentioned method for determining a compression model for compressing channel state information when executed by the programmable device.

FIG. 25 is a block diagram of a network device according to an embodiment. For example, the network device 2500 may be provided as a base station, or may be provided as other network logic entities in a core network. Referring to FIG. 25, the network device 2500 includes a processing component 2522, which further includes one or more processors, and a memory resource represented by a memory 2532 for storing instructions executable by the processing component 2522, such as an application. The application stored in the memory 2532 may include one or more modules, each of which corresponds to a set of instructions. In addition, the processing component 2522 is configured to execute instructions to execute the steps of the method for determining a compression model for compressing channel state information provided in the above-mentioned method embodiment.

The network device 2500 may also include a power component 2526 configured to perform power management of the device 2500, a wired or wireless network interface 2550 configured to connect the network device 2500 to a network, and an input/output (I/O) interface 2558. The network device 2500 may operate based on an operating system stored in the memory 2532, such as Windows Server™, Mac OS X™, Unix™, Linux™, FreeBSD™, or the like.

In another illustrative embodiment, a computer program product is also provided, which includes a computer program executable by a programmable device, and has a code portion for executing the above-mentioned method for determining a compression model for compressing channel state information when executed by the programmable device.

Other embodiments of the present disclosure will be apparent to those skilled in the art from consideration of the specification and practice of the present disclosure. The present disclosure is intended to cover any variations, uses, or adaptations of the present disclosure following the general principles thereof and including common knowledge or commonly used technical means which are not disclosed by the present disclosure. It is intended that the specification and examples be considered as illustrative only, with a true scope and spirit of the present disclosure being indicated by the scope of the following claims.

It will be appreciated that the present disclosure is not limited to the exact construction that has been described above and illustrated in the accompanying drawings, and that various modifications and changes may be made without departing from the scope of the present disclosure. It is intended that the scope of the present disclosure only be limited by the scope of the appended claims.

1. A method for determining a compression model for compressing channel state information, performed by a terminal, comprising:
receiving model information sent by a network device, wherein the model information comprises a first model parameter of a decompression model, and the decompression model is used by the network device to decompress the channel state information sent by the terminal;
determining the compression model used by the terminal to compress the channel state information based on the model information.

2. The method according to claim 1, wherein the model information further comprises a second model parameter of the compression model corresponding to the decompression model.

3. The method according to claim 1, wherein determining the compression model used by the terminal to compress the channel state information based on the model information comprises:
training and obtaining the compression model corresponding to the decompression model based on the first model parameter.

4. The method according to claim 3, wherein training and obtaining the compression model corresponding to the decompression model based on the first model parameter comprises:
training and obtaining the compression model corresponding to the decompression model locally by the terminal; or,
sending an obtaining request to a server, and obtaining the compression model corresponding to the decompression model sent by the server.

5. The method according to claim 2, wherein determining the compression model used by the terminal to compress the channel state information based on the model information comprises:
optimizing the second model parameter to obtain a third model parameter;
establishing the compression model for compressing the channel state information based on the third model parameter.

6. The method according to claim 2, wherein determining the compression model used by the terminal to compress the channel state information based on the model information comprises:
establishing the compression model for compressing the channel state information based on the second model parameter.

7. The method according to claim 1, wherein the compression model used by the terminal to compress the channel state information satisfies at least one of model performance conditions:
a mean square error or a normalized mean square error being less than a first preset threshold in a case that the compression model and the decompression model are used together;
a cosine similarity being greater than a second preset threshold in a case that the compression model and the decompression model are used together;
a square of the cosine similarity being greater than a third preset threshold in a case that the compression model and the decompression model are used together; or
a signal-to-noise ratio being greater than a fourth preset threshold in a case that the compression model and the decompression model are used together.

8. The method according to claim 1, wherein the model information comprise first model parameters of a plurality of decompression models; or, the model information comprises the first model parameters of the plurality of decompression models and second model parameters of compression models corresponding to the plurality of decompression models respectively.

9. The method according to claim 8, wherein determining the compression model used by the terminal to compress the channel state information based on the model information comprises:
determining a model parameter of a target model from the model information at least based on at least one of capability information of the terminal or frequency band information used by the terminal, wherein the target model is the decompression model or the compression model;
determining the compression model used by the terminal to compress the channel state information based on the model parameter of the target model.

10. The method according to claim 9, further comprising:
reporting the target model determined by the terminal to the network device,
wherein reporting the target model determined by the terminal to the network device comprises:
reporting identification information of the target model to the network device; or,
reporting at least one of the capability information of the terminal or the frequency band information used by the terminal to the network device, wherein at least one of the capability information of the terminal or the frequency band information used by the terminal is used by the network device to determine the target model determined by the terminal.

11. (canceled)

12. The method according to claim 1, further comprising:
determining an activation time of the compression model based on a preset duration in a communication protocol or a preset duration configured by the network device, wherein the preset duration is a duration relative to a specific moment,
wherein the specific moment comprises at least one of an end moment when the terminal finishes receiving a physical downlink shared channel (PDSCH) containing the model information, or a moment when the terminal feeds back a last symbol of an uplink resource for hybrid automatic repeat request-acknowledgement (HARQ-ACK) information of the PDSCH comprising the model information.

13. (canceled)

14. A method for determining a compression model for compressing channel state information, performed by a network device, comprising:
sending model information, wherein the model information comprises a first model parameter of a decompression model, the decompression model is used by the network device to decompress the channel state information sent by a terminal, and the model information is used by the terminal to determine the compression model for compressing the channel state information.

15. The method according to claim 14, wherein the model information further comprises a second model parameter of the compression model corresponding to the decompression model.

16. (canceled)

17. The method according to claim 14, wherein sending the model information comprises:
sending the model information in a broadcast mode for a terminal that is not connected to the network device;
sending the model information in a unicast mode or a multicast mode for a terminal or a terminal group that is connected to the network device.

18. The method according to claim 17, wherein sending the model information in the unicast mode or the multicast mode for the terminal or the terminal group that is connected to the network device comprises:
in response to at least one of terminal capability information or frequency band information sent by the terminal or the terminal group, sending the model information in the unicast mode or the multicast mode for the terminal or the terminal group that is connected to the network device,
wherein model information sent by the network device are different for terminals or terminal groups with at least one of different terminal capability information or different frequency band information.

19. (canceled)

20. The method according to claim 14, wherein the model information comprise first model parameters of a plurality of decompression models; or, the model information comprises first model parameters of the plurality of decompression models and second model parameters of compression models corresponding to the plurality of decompression models respectively.

21. The method according to claim 20, further comprising:
receiving a target model determined and reported by the terminal, wherein the target model is determined by the terminal from the model information, and a model parameter of the target model is used by the terminal to determine the compression model for compressing the channel state information.

22. The method according to claim 14, wherein the network device is a base station, and sending the model information comprises:
sending the model information via a radio resource control (RRC) signaling; or
wherein the network device is an access and mobility management function (AMF) network element in a core network, and sending the model information comprises:
sending the model information via a non-access stratum (NAS) signaling.

23-25. (canceled)

26. A device for determining a compression model for compressing channel state information, comprising:
a processor;
a memory for storing instructions executable by the processor;
wherein the processor is configured to:
receive model information sent by a network device, wherein the model information comprises a first model parameter of a decompression model, the decompression model is used by the network device to decompress the channel state information sent by the terminal;
determine the compression model used by the terminal to compress the channel state information based on the model information.

27. A device for determining a compression model for compressing channel state information, comprising:
a processor;
a memory for storing instructions executable by the processor;
wherein the processor is configured to perform the method according to claim 14.

28. (canceled)
